(19) United States
(12) Patent Application Publication
(10) Pub. No.: US 2019/0159953 A1
(43) Pub. Date: May 30, 2019

(54) WEARABLE DEVICES AND METHODS FOR TREATMENT OF FOCAL DYSTONIA OF THE NECK, HEAD AND VOICE

(71) Applicant: Regents of the University of Minnesota, Minneapolis, MN (US)

(72) Inventors: Jürgen Konczak, Minneapolis, MN (US); Arash Mahnan, Minneapolis, MN (US)

(73) Assignee: Regents of the University of Minnesota, Minneapolis, MN (US)

(21) Appl. No.: 16/201,230

(22) Filed: Nov. 27, 2018

Related U.S. Application Data
(60) Provisional application No. 62/591,301, filed on Nov. 28, 2017.

(51) Int. Cl. A61H 1/00

(52) U.S. Cl. CPC A61H 1/005; A61H 2201/165; A61H 2201/1609; A61H 2201/5097; A61H 2230/085; A61H 2201/5084; A61H 2201/5007; A61H 2201/5048

(57) ABSTRACT

The disclosure relates to wearable devices and methods that utilize laryngeal or neck vibro-tactile stimulation (VTS) as a non-invasive form of neuromodulation that induces measurable improvements in the patients with focal dystonia of the head, neck and voice including cervical dystonia and/or spasmodic symptoms.

### RELATED APPLICATIONS

This Non-Provisional Patent Application claims the benefit of the filing date of U.S. Provisional Patent Application Ser. No. 62/591,301, filed Nov. 28, 2017, entitled “WEARABLE DEVICES AND METHODS FOR TREATMENT OF SPASMODIC DYSPHONIA,” the entire teachings of which are incorporated herein by reference.

### BACKGROUND

Focal dystonia is a movement disorder characterized by involuntary muscle contractions and spasms that typically affect specific parts of the body. Cervical dystonia (CD), also called spasmodic torticollis, is the most common form of focal dystonia involving the neck region and sometimes shoulders. It caused abnormal movements and awkward postures of the head and neck. The movements may be sustained (‘tonic’), jerky (‘clonic’), or a combination. The underlying mechanisms of focal dystonia are not fully understood, but the motor symptoms have been linked to abnormal neural processing in the basal ganglia-thalamocortical loop and the cerebello-thalamocortical circuitry.

Spasmodic dysphonia (SD) is a form of focal dystonia affecting the larynx. It is rare voice disorder more prevalent in women that develops spontaneously during midlife. Spasmodic dysphonia is characterized by involuntary, random movement of laryngeal muscles causing disruption of fluent speech with strained-strangled voice quality. Patients with spasmodic dysphonia typically have a strained or choked speech and report that is takes an exhausting effort to speak. There are two types of SD: (a) adductor (AD) typified by uncontrolled vocal fold closure; and (b) abductor (AB) characterized by uncontrolled vocal fold opening. The AD form is more common and typically occurs during the voiced components of speech. Spasmodic dysphonia symptoms are task specific, occurring during speech but not during other phonatory (e.g., prolonging vowels) or non-phonatory tasks (e.g., breathing).

Current treatment options for patients with cervical dystonia and/or spasmodic dysphonia are limited. Spasmodic dysphonia generally does not respond to behavioral speech therapy. It is primarily treated with botulinum toxin injections, which provides temporary symptom relief to some, but is not well tolerated by all spasmodic dysphonia patients. Botulinum toxin symptom relief is greatest shortly after injection and will slowly decay over time. At present, there is no cure for spasmodic dysphonia. The same is true for people with CD. They can receive temporary symptom relief through the injection of Botulinum toxin in the affected neck muscles. At present, there is no cure for cervical dystonia.

The present disclosure provides devices and methods for the treatment of focal dystonia affecting the human head, neck and voice system such as spasmodic dysphonia and cervical dystonia.

### SUMMARY

The present inventors have established that spasmodic dysphonia, like other forms of focal dystonia, is associated with proprioceptive dysfunction. The disclosure relates to wearable devices and methods that utilize laryngeal vibro-tactile stimulation (VTS) as a non-invasive form of neuromodulation that induces measurable improvements in the speech and voice symptoms of patients with spasmodic dysphonia.

The present inventors have further established that cervical dystonia, like other forms of focal dystonia, is associated with proprioceptive dysfunction. The disclosure relates to wearable devices and methods that utilize vibro-tactile stimulation (VTS) of the neck muscles as a non-invasive form of neuromodulation that can induce measurable improvements in the head posture speech and voice symptoms of patients with spasmodic dysphonia.

Aspects of the disclosure include a wearable vibration device, positioned around the neck of a user that vibrates the skin above the larynx and/or the neck. Various embodiments are configured to be light-weight, battery operated, and programmable through a mobile-phone or tablet-based application. Users can wear the device freely during the day and activate treatment, as needed. Some embodiments can include embedded microphones, accelerometers, inertial, or electromyographic sensors to further customize and automatize vibrator behavior. For example, the laryngeal vibration device can be configured such that the vibrators are only activated (i.e. turned on) while the user is speaking with embedded speech detection and recognition technologies automatically determining onset and offset of the user's speech based on the analysis of the acoustic signal of the wearable microphone. In another embodiment, the vibrators are turned on, when the neck musculature involuntarily contracts or spasms and the electromyographic sensors embedded in the device sense abnormal levels of muscle activity. In other embodiments, the vibrators are activated for a certain duration (e.g., 10 minutes or between 1 minute to 2 hours or another period of time as determined by the life of a battery powering the vibrators) or are toggled between on/off based on user selection.

Disclosed devices and methods provide people with spasmodic dysphonia and/or cervical dystonia with a behavioral treatment option for reducing the frequency and magnitude of the dystonic symptoms of their voice and/or neck.

### BRIEF DESCRIPTION OF THE DRAWINGS

FIG. 1 is a schematic illustration of a laryngeal vibration device having vibrators carried by a collar that can be used to treat spasmodic dysphonia.

FIG. 2 is a schematic illustration of a neck vibration device largely similar to that of FIG. 1 having vibrators positioned to treat cervical dystonia.

FIG. 3 is a schematic illustration of the laryngeal and/or neck vibration device of FIG. 1 and FIG. 2 operatively secured around a user's neck.

FIG. 4 is a photograph of the position of the vibrators on the user's neck having the collar removed so that the position of the vibrators can be seen (the position of the vibrators refers to the device FIG. 1 and their use in treating spasmodic dysphonia).

FIG. 5A shows the neural circuitry underlying the vibro-tactile vibration of the larynx in accordance with methods of the disclosure.

FIG. 5B shows the neural circuitry underlying the vibro-tactile vibration of the neck muscle in accordance with methods of the disclosure.

FIG. 6 is a schematic diagram of the sensory and motor neural systems and their projections involved during speech and vocalization while laryngeal vibro-tactile stimulation is applied.

FIG. 7 is a block diagram of various hardware components and the process flow of the laryngeal vibration device.

FIG. 8 is a graph of vibration motor performance characteristics of one vibrator that can be used in the disclosed laryngeal vibration devices.

FIG. 9 includes a photograph of a subject prepared for EEG recording having a single vibrator taped to the larynx and also a frequency-time spectrogram of a single electrode located above the right motor cortex (B13=FC4) based on N=100 trials.

FIG. 10 is a diagram of one example experimental setup in which two sets of VTS were applied, each lasting 17 minutes (7 min only VTS; 10 min vocalization with VTS).

FIG. 11 displays frequency-time spectrograms of the mean change in event-related spectral power (ERSP) with respect to rest based on 50 epochs.

FIG. 12 displays changes in ERSP in the 5-30 Hz band for two SD patients indicating the effect of bilateral VTS on vocalization.

### DETAILED DESCRIPTION

The present inventors have established proprioceptive deficits in spasmodic dysphonia demonstrating that an underlying somatosensory deficit is a feature of spasmodic dysphonia. This finding opens an avenue for a missing behavioral treatment for spasmodic dysphonia. Specifically, the present inventors believe that vibro-tactile stimulation (VTS) is a suitable tool, given that VTS alters afferent signals from the vibrated muscle spindles of the laryngeal musculature and the tactile mechanoreceptors in the skin above the larynx. The mucosa of the epiglottis has a dense array of mechanoreceptors that respond to a wide range of entrainment frequencies (optimal 10-70 Hz) and are sensitive to depression of <100 μm amplitudes. Further, a finding of Krause type sensory corpuscles at the free edge of the vocal cords underlines the present inventors' notion that many of these mechanoreceptors provide proprioceptive feedback not only useful for swallowing but for voice control.

The present inventors and other researchers have established proprioceptive deficits in cervical dystonia demonstrating that an underlying somatosensory deficit is a feature of cervical dystonia. This finding opens an avenue for a missing behavioral treatment for spasmodic dysphonia. Specifically, the present inventors believe that vibro-tactile stimulation (VTS) is a suitable tool, given that VTS alters afferent signals from the vibrated mechanoreceptors (muscle spindles of neck muscles and tactile mechanoreceptors in the skin above the neck musculature).

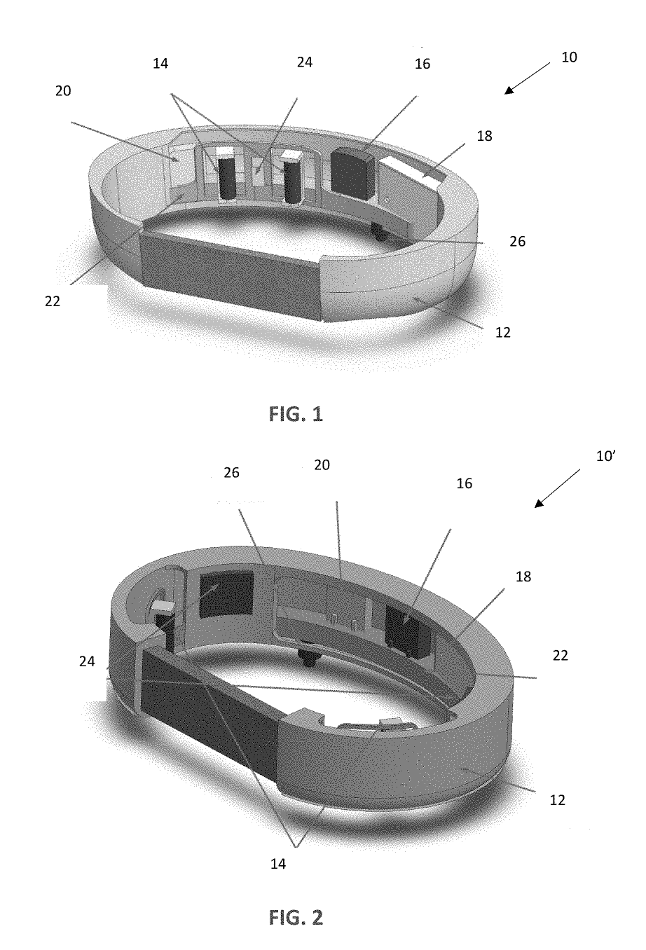

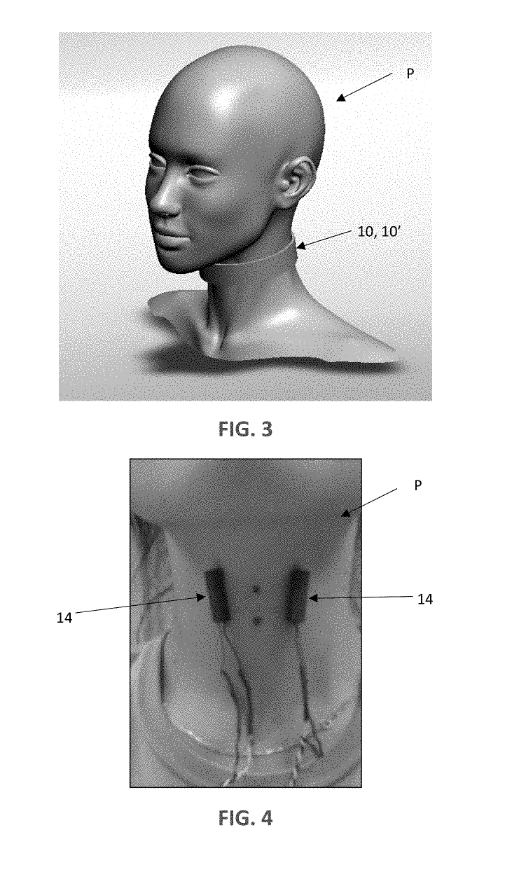

One embodiment 10 incorporating aspects of the disclosure is schematically illustrated in FIG. 1. The laryngeal vibration device 10 includes a collar 12 housing two encapsulated vibrators 14 (referenced jointly). The collar 12 can further house electronic circuitry 16 for controlling the vibrators 14 as well as a power source 18 (e.g., rechargeable battery). The collar 12 can be configured such that the electronic circuitry 16 and rechargeable battery 18 can be detached from the collar 12 so that the collar 12 can be washed and reused, as desired. The collar 12 can optimally be made of textile materials having various stiffness and compliance to assure that the vibrators 14 are in contact with the skin during use. In some embodiments, the collar 12 will be snug fitting, soft, wear-resistive and water resistant. Additionally, the collar 12 can be configured such that the position of each vibrator 14 on the collar 12 is adjustable in order to confirm to the individual neck and larynx anthropometrics of a specific user or patient P. FIGS. 3-4 illustrate one anatomical position of both the collar 12 and the vibrators 14 with respect to a neck of the patient P (in FIG. 4 only the vibrators 14 and associated wiring are shown for ease of illustration). As shown in FIG. 4, the vibrators 14 are positioned on opposing sides of thyroid cartilage of the larynx. The device 10 can optionally further include a wireless panel 20 as will be discussed in greater detail below. To house one or more components, the device 10 can optionally include a holding band 22, configured to support one or more components such at the vibrators 14, electronic circuitry 16, battery 18 and any provided sensors/microphones/accelerometers (generally referenced as 24) utilized to indicate when the vibrators 14 should be actuated, as will be discussed in greater detail below. The holding band 22 can be flexible, yet more rigid as compared to the collar 12. The holding band 22 can optionally be fabricated using 3D printing or otherwise. The holding band 22 can be embedded in the collar 12 (e.g., positioned within pockets formed in the collar 12, which are not shown). As stated above, in some embodiments, the holding band 22 can be removed from the collar 12 so that the collar 12 can be cleaned separately. In addition, the device 10 includes an on/off power switch 26.

The components of the device 10 of FIG. 1 described herein can be rearranged based on the particular type of focal dystonia to be treated. For example, referring now in addition to FIG. 2, an alternate device 10′ can be configured such that the vibrators 14 are positioned on opposing sides of the collar 12. It will be understood that, as like reference numbers indicate, the components of the device 10′ are otherwise identical to those of the device 10 of FIG. 1 in both their configuration, operation and use except as explicitly stated.

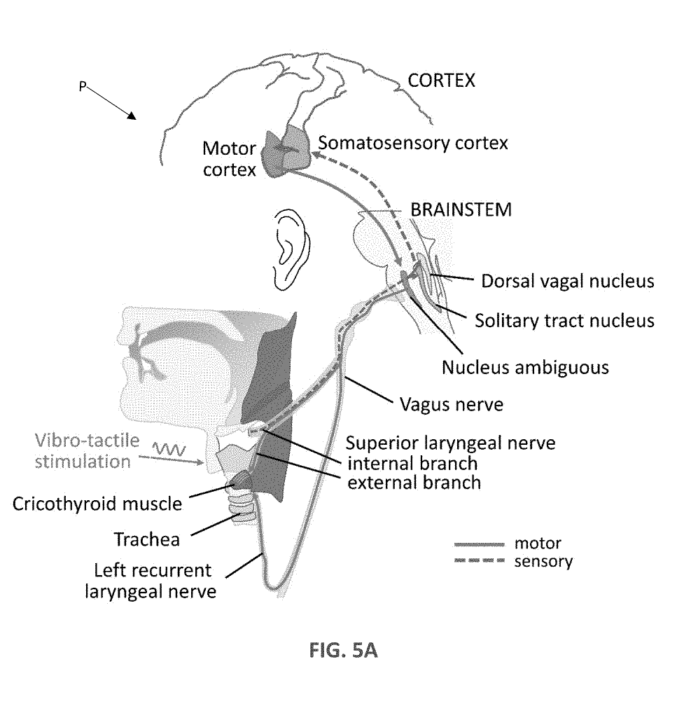

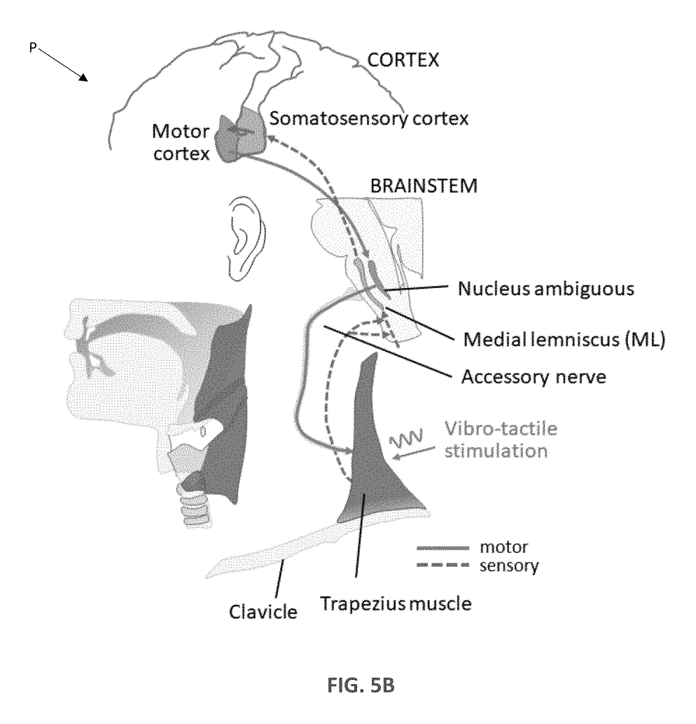

Referring now also to FIG. 5A, FIG. 5A shows the neural circuitry underlying the vibro-tactile vibration of the larynx of a patient P that can be applied by the device 10. As vibro-tactile stimulation is applied to the skin above the voice box, sensory signals from laryngeal mechanoreceptors propagate through the sensory branch of the vagus nerve to the brainstem and ultimately to the laryngeal area of somatosensory cortex. Somatosensory cortex sends large projections to laryngeal motor cortex, which itself sends efferent projections via brain stem nuclei and the motor branch of the vagus nerve to the muscles controlling the vocal folds during vocalization and speech.

Referring now to FIG. 5B, FIG. 5B illustrates neural circuitry underlying the vibro-tactile vibration of the posterior portion of the neck of a patient P that can be applied by the device 10′. As vibro-tactile stimulation is applied to the skin above the trapezius muscle, sensory signals from mechanoreceptors embedded in the skin and the muscle propagate through the sensory nerves to the brainstem and ultimately to the neck area of somatosensory cortex. Somatosensory cortex sends large projections to motor cortex, which sends efferent projections via brain stem nuclei and the accessory nerve to the muscles controlling the neck musculature.

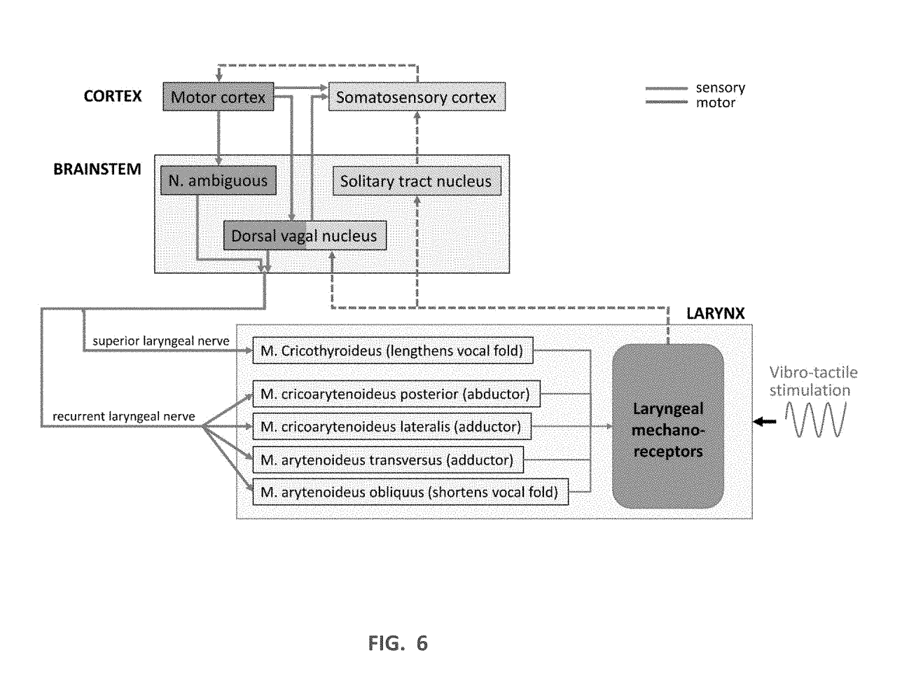

Referring now in addition to FIG. 6, FIG. 6 is a schematic diagram of the patient's P sensory and motor neural systems and their projections involved during speech and vocalization while laryngeal vibro-tactile stimulation is applied during use of the device 10. Vibration of the skin above the voice box will stimulate the mechanoreceptors of the internal and external laryngeal muscles, and receptors embedded in the muscosa of the epiglottis and the vocal folds (in this illustration, all are grouped as laryngeal mechanoreceptors).

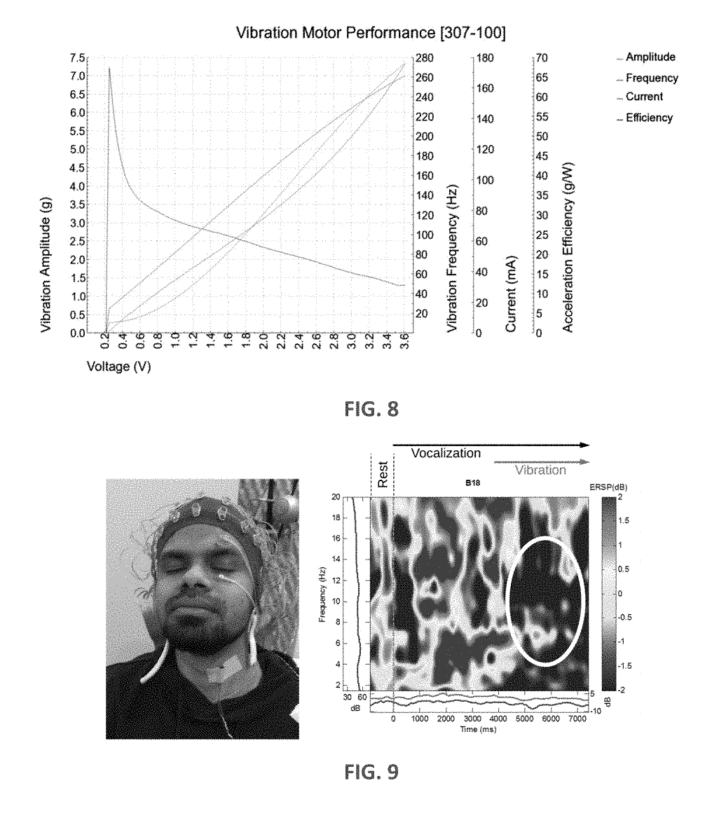

The vibratory motor 14 (i.e. vibrator) used with the embodiments disclosed herein are used to apply stimulation to the patient's P larynx or posterior portions of the neck (e.g. skin above the trapezius and/or sternocleidomastoid muscles). As will be understood, the power supply 18, in some embodiments is a battery (optionally rechargeable), that is sufficient to power the vibrators 14. In various embodiments, the length of time in which the power supply 18 can power the vibrators 14 may dictate the length of treatment (i.e. the length of time in which vibration is applied to the patient P). In some embodiments, the power supply 18 is such that the voltage applied to the vibrators 14 ranges between about 1 to about 1.5 V. In some embodiments, the vibrators 14 are small precision DC motors that deliver amplitudes between 1.7-14.3 G (based on 100 g inertial load testing). During human subject testing, it became clear to the present inventors that vibrators with amplitudes above 6G are unsuitable (e.g., such vibrators induced a gag reflex at higher voltage; were uncomfortable to wear for prolonged periods of time (>10 min), while others do not provide sufficient amplitude). The vibrators 14 can be coin or encapsulated eccentric cylinders, for example. One example includes a coin vibrator having a 12 mm diameter and thickness of 3.4 mm. In yet a further embodiment, each vibrator 14 is an encapsulated cylinder vibrator having a length of 25 mm and a diameter of 8.8 mm. One specific example is Precision Microdrives Type 307-100 available from Precision Microdrives Ltd, London, United Kingdom. Properties of the Precision Microdrives Type 307-100 vibrator are listed below in Table 1 and also presented in FIG. 8.

TABLE 1
Properties of Precision Microdrives Type 307-100.

| | | |
|---|---|---|
| Body Diameter | 8.8 | mm |
| Body Length | 25 | mm |
| Unit Weight | 4.6 | g |
| Typical Operating Current | 130 | mA |
| Typical Power Consumption | 390 | mW |
| Typical Normalized Amplitude | 6 | G |
| Rated Voltage | 3 | V |
| Rated Speed | 13,500 | rpm |
| Typical Lag Time | 6 | ms |
| Typical Rise Time | 22.5 | ms |
| Typical Stop Time | 56.5 | ms |

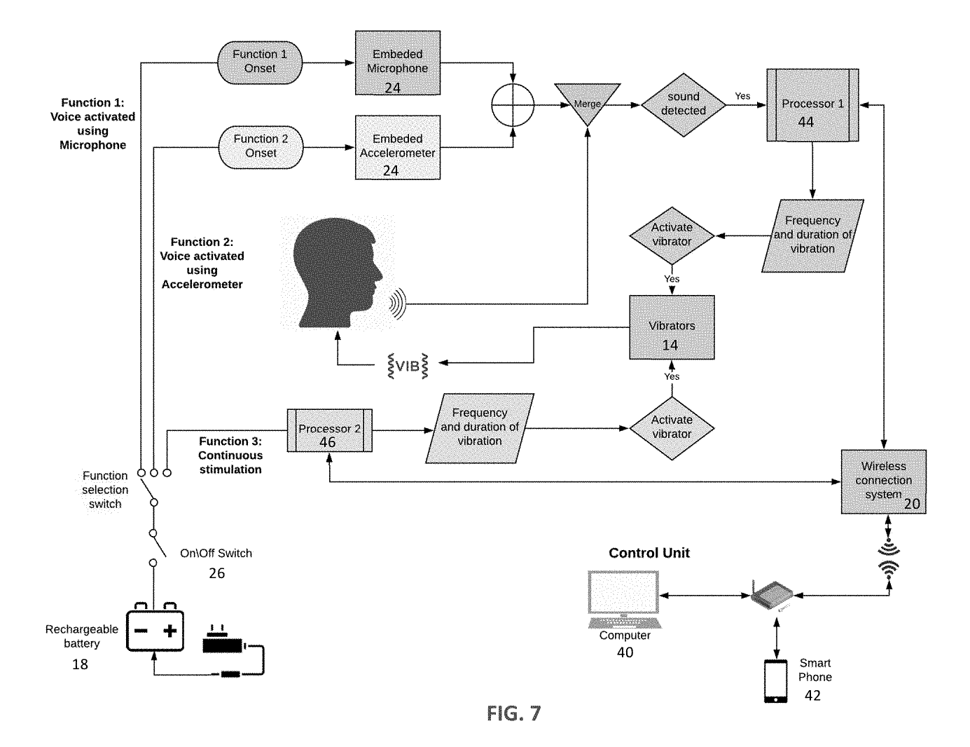

Turning now also to FIG. 7, the wireless panel 20 can incorporate Bluetooth wireless technology or the like and can optionally be used for device 10/10′-control unit 40/42 communication, because of its low-power consumption and good compatibility with existing mobile devices. In some embodiments, the control unit 42 will be an Android OS tablet or smartphone 42. Other similar types of operating systems and devices are envisioned. A rechargeable lithium polymer battery (4.2V) or the like can serve as power supply obviating the need of power supply cables that restrict patient movement. A control circuit can be provided to manage power consumption (e.g., on/off switch 26), tune the vibration frequency and magnitude, and communicate with the tablet/smartphone application.

As also generally depicted in FIG. 7, various embodiments are configured to apply VTS in one of two modes. The modes can optionally include: 1) a voice activated mode in which stimulation is only active during vocalization or speech of the user/patient; and 2) a continuous stimulation mode in which the user/patient either turns the stimulation on or off manually via the control unit (e.g., a computer 40, smartphone or the like 42) or sets the duration of stimulation via a software timer in the application of the control unit 40/42. In some embodiments, the user can also set and modify the stimulation parameters, frequency and amplitude of vibration, via the control unit 40/42.

In embodiments where the vibrators 14 are active during user speech, the laryngeal vibration device 10 is configured to detect the user's voice using one or more microphones, or other type of sensors (generally referenced as 24) built into the laryngeal vibration device 10 such as accelerometers, electromyographic sensor (e.g., SN2020 from UltraStim® Snap available from AXELGAARD MANUFACTURING CO., LTD. of Fallbrook, Calif.) or inertial sensors (e.g., ADXL345 small, thin, ultralow power, 3-axis accelerometer with high resolution (13-bit) measurement at up to ±16 g by Analog Devices, Inc. of Norwood, Mass.). In one optional embodiment, the microphone 24 is positioned on the collar 12, between the two vibrators 14. Alternate configurations are also envisioned. The microphone(s) 24 send input to the electronic circuitry 16. The electronic circuitry 16 subsequently activates the vibrators 14 within certain frequency and duration, using speech detection technology. The delay for activation of the vibrators 14 is optionally less than 0.1 s so that VTS begins almost immediately as the user begins speaking. The frequency of vibration is modulated via regulating the voltage and current. The frequency and amplitude of the vibrators 14 can be assigned using a computer, smartphone or tablet-based application. The laryngeal vibration device 10 can be connected to a computer using a wireless connection (e.g., Bluetooth) provided by wireless panel 20. In various embodiments, these processes occur in real-time and all of the processing can either happen in the electrical circuitry 16 embedded in the laryngeal vibration device 10 or in other processors 44, 46 that are connected to the device 10 via the wireless panel 20. In some embodiments, the ability to send the real-time data to the computer, for the purposes of recording the status of the laryngeal vibration device 10, is added to the electronic circuitry 16. In yet another embodiment, a surface electromyographic sensor or electrode 24 is utilized to monitor activity of superficial neck muscles involved in vocalization and speech as an alternative to the microphone 24. Embodiments of the disclosure (e.g., device 10′) are also suitable to monitor activity of neck muscles of a patient P involved in head turning or tilting (e.g., m. sternocleidomastoideus, m. trapezius). In yet another embodiment, an accelerometer or inertial sensor records the accelerations of patient P skin tissue above the voice box to monitor the onset and offset of vocalization and speech (the accelerometer and inertial sensor are generally referenced at reference number 24).

In embodiments where the vibrators 14 are activated (i.e. on) for a certain duration (e.g., between 1 to 2 hours in some embodiments, or 10 minutes or more in other embodiments, for example), the electronic circuitry 16 turns the vibrators 14 on for the pre-established amount of time. The frequency of vibration of the vibrators 14 is modulated via regulating the voltage and current. The processor 46, in some embodiments, is programmed via computer software using a built-in wireless panel 20 and connection.

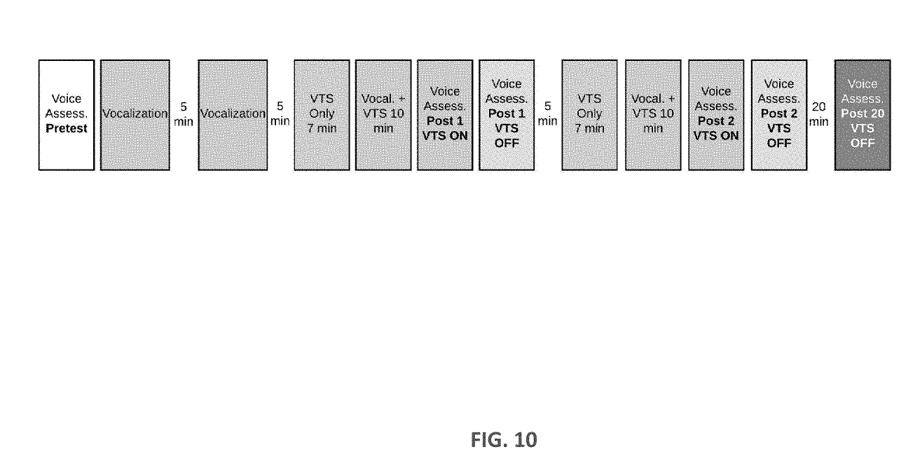

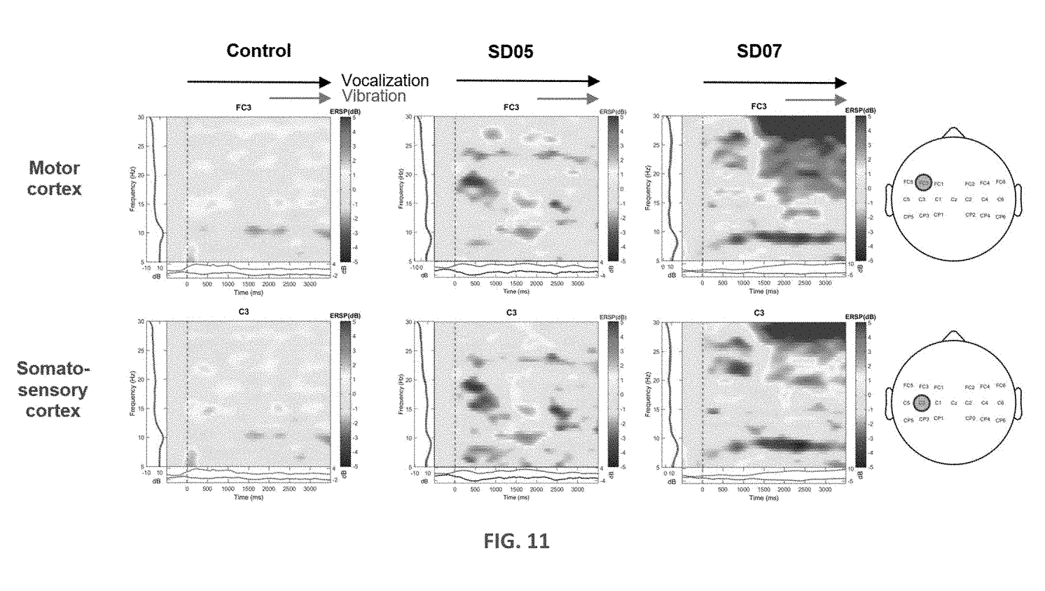

FIG. 11 illustrates the result of the example test following the protocol shown in FIG. 10. Frequency-time spectrograms of the mean change in event-related spectral power (ERSP) with respect to rest based on 50 epochs is illustrated in FIG. 11. Shown are the baseline related changes in vocalization and vocalization+VTS for one healthy control and two SD participants after exposure to 30 min of VTS (10 min VTS at rest; 20 min vocalization+VTS). For each epoch, subjects were initially at rest (−500 to 0 ms), began to vocalize the vowel ‘ahh’ at time stamp 0 ms for approximately 4000 ms. Vibrator was turned on at 2000 ms. Maps are for two electrodes FC3 (above middle frontal gyms, area 6) and C3 (postcentral gyms, area 1,2,3). Note the reduction in spectral power in alpha/mu band activity in somatosensory (C3) and motor cortex (FC3) indicating desynchronization of neural activity, which becomes most pronounced when vibrators were turned on. In contrast to SD05 (Abductor SD), SD07 (Adductor SD) revealed increased levels of synchronization in beta-band cortical activity. The present inventors do not have sufficient evidence from other SD patients to conclude that this is a consistent feature of adductor SD.

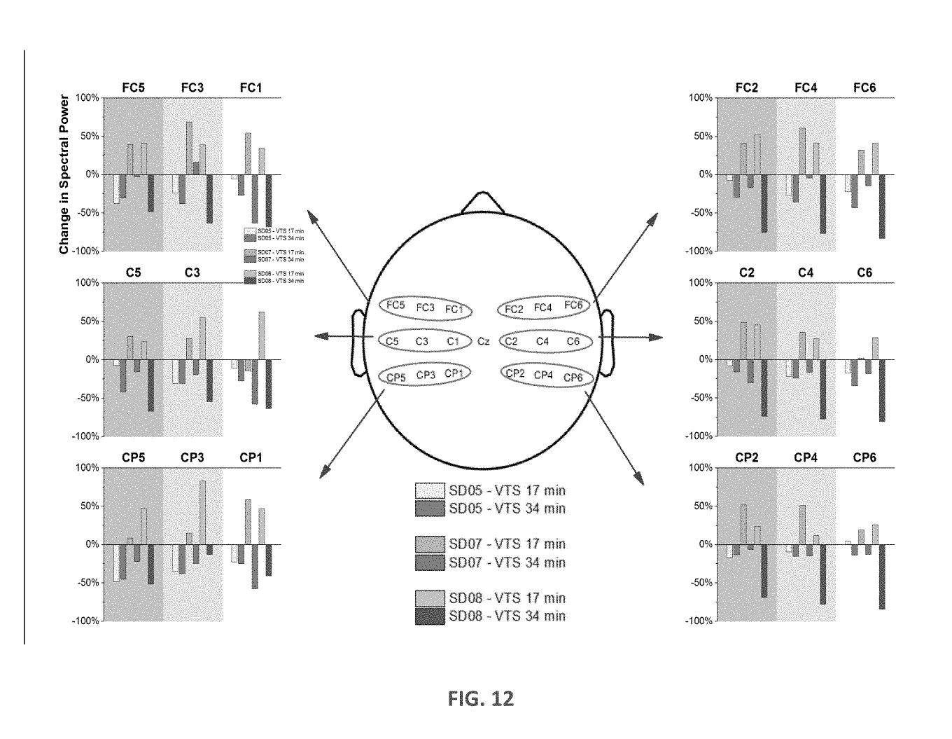

Now referring in addition to FIG. 12, each bar shown are responses for the first and second set of applying VTS (after 17 and 34 min). SD05 showed a consistent decrease in ERSP for both sets. For SD07, ΔERSP increased in the first 10 minutes and then decreased in the second set, indicating that cortical responses evolve over time and prolonged VTS may enhance the desynchronization over sensorimotor cortex.

### Example 1

The present inventors discovered that in order for laryngeal VTS to have any acute effect on the voice quality in SD, it must modulate the activity of sensorimotor networks involved in somatosensory processing and speech motor control. It has been established that vibration of hand muscles at a frequency of 60 Hz induces a marked amplitude depression of somatosensory evoked potentials of healthy humans. Yet, no data were available on the somatosensory evoked potential (SEP) response to laryngeal vibration and no data exist on how prolonged vibration of the voice box over minutes affects neural processing. The present inventors therefore assessed the cortical responses associated with laryngeal VTS in four healthy adult volunteers while they vocalized the vowel ‘ahh’, and contrasted them with responses during rest (no vocalization, no vibration) and a vocalization only condition. Voice recordings and 64-channel electroencephalogram (EEG) signals (sampled at 512 Hz) from the scalp were recorded in a soundproof and electrically shielded chamber. Each trial (N=100) consisted of a rest period, followed by 8 seconds of continuous vocalization. Four seconds after the beginning of vocalization, a single vibrator on the left side of the larynx was turned on (see, FIG. 4). EEG data were filtered offline and conditioned using established protocols to remove signal artifacts (e.g., ocular, heart, head muscle activity, power lines). The present inventors discovered that laryngeal VTS induced a marked depression of cortical activity in somatosensory and motor cortical areas in the 2-120 Hz range, including alpha (7-14 Hz), mu (8-13 Hz), and beta (15-30 Hz) bands. The suppression was bilateral, but more pronounced contralateral to the vibration site. Mu rhythm is attributed to synchronization of motor cortical neurons. FIG. 6 shows the mean changes in the spectral power Event Related Spectral Perturbation (ERSP) with respect to pre-stimulus baseline of one subject for one electrode over the right motor cortex (contralateral to VTS stimulation). For the sake of brevity, only one electrode is shown in FIG. 6, for more complete ERSP maps showing the effects of VTS in healthy controls and SD patients see FIGS. 8 and 9 and related disclosure. Based on our voice and cortical activation data the present inventors believe that 90 Hz is a particularly effective stimulation frequency.

Through the above-described preliminary work, the present inventors established in a small sample of healthy subjects (N=4) that VTS has an immediate effect on somatosensory and motor cortical processing. VTS does induce a marked depression of cortical activity that lasts for the duration of vibration. This preliminary finding provided evidence that embodiments of this disclosure induce a measurable neural effect at the level of the sensorimotor cortex.

### Example 2

After the establishing the neural response in somatosensory and motor cortical areas to the VTS setup described above, ten additional healthy controls and 10 SD patients were tested with the protocol outlined in FIG. 10. The SD patients were seen at the end of their botulinum toxin cycle when they were symptomatic. Similar to the preliminary work described above, participants performed vocalization while exposed to bilateral laryngeal vibration. They received two sets of 17 minutes of VTS. Audio recordings of the voice assessment battery and self-report data on vowel and sentence production were collected at the end of each vibration period (Post1,2-ON) and after VTS was turned off (Post1,2-OFF). In addition, retention of VTS effects on voice was tested 20 minutes after the last posttest (Post2-OFF). The aim of this study was to confirm that: a) cortical suppression due to VTS as seen in healthy adults can also be observed in SD patients; and b) that such suppression is associated with an acute decrease in SD symptoms.

The present inventors found that VTS, as conducted, induced a marked desynchronization in somatosensory (Area 1,2,3) and motor cortical areas (Area 4,6) based on the anatomical correlation data by Koessler, L., et al., Automated cortical projection of EEG sensors: anatomical correlation via the international 10-10 system. Neuroimage, 2009. 46(1): p. 64-72. Cortical suppression was most pronounced and consistent in alpha (7-14 Hz) and mu (8-13 Hz) bands, and more variable across SD participants in the beta (15-30 Hz) band. This motor cortical desynchronization seen here in SD is consistent with research on cervical dystonia (CD) showing that effective sensory tricks (e.g. touching specific areas of skin at of the head or neck) are associated with pallidal and motor cortical desynchronization at low frequencies (6-8 Hz). That is, VTS elicited a similar cortical response in SD like a sensory trick that effectively reduces dystonic symptoms in CD. FIG. 8 shows the respective ERSP maps for a healthy control and two SD participants (SD 05; SD 07).

To further quantify the effect of VTS on cortical activity over sensorimotor cortical areas, the present inventors computed the change in spectral power (SP) in the 5-30 Hz range as follows: ΔERSP=(SP_{vocalization+VTS}×SP_{vocalization})/SP_{vocalization}. If prolonged VTS indeed induces a systematic desynchronization of cortical activity, the present inventors expected to see, at minimum, a reduction in ERSP from the first to the second application of VTS (from set 1 to set 2). FIG. 12 details the ERSP change over 18 EEG sensor locations bilaterally to illustrate the changes in cortical activation observed over parieto-frontal regions comprising primary somatosensory, primary motor and premotor cortex.

The present inventors found that after 10 minutes of VTS, a decrease in ΔERSP of up to 48% was observable (see SD05) and of up to 58% after 20 min of VTS exposure (see SD07). The data indicate that prolonged VTS beyond 10 minutes may still yield observable changes indicative of increased desynchronization of the sensorimotor cortical networks involved in voice production. Further systematic analysis of all ten SD patients showed VTS was associated with a significant suppression of theta band power over left somatosensory-motor cortex and a significant rise of gamma rhythm over right somatosensory-motor cortical areas

Thus, Applicant obtained evidence that sensorimotor cortical networks for voice production in SD patients respond to VTS. The response indicates a suppression or desynchronization of neuronal activity above somatosensory and motor cortical areas. A similar response has been reported when applying effective sensory tricks or deep brain stimulation in other forms of focal dystonia. It further shows that these cortical changes persist over minutes and may become more enhanced after prolonged VTS beyond 30 minutes.

The protocol (see section above) also generated a series of voice data that allowed the present inventors to measure, if VTS induced any changes in voice quality. Recordings were anonymized, randomized and scored by a blinded investigator to safeguard against experimental bias. An acoustic analysis was performed on speech samples from the audio recordings using P., B. and W. W., Praat: A System for Doing Phonetics By Computer Version 4.4.30. 2005: Amsterdam: Institute of Phonetic Sciences. Spoken stimuli analyzed were the 20 sentences shown in Ludlow, C. L., et al., Research priorities in spasmodic dysphonia. Otolaryngology—Head and Neck Surgery, 2008. 139(4): p. 495-505.e1. (“Ludlow”). For each sentence analysis consisted of: (1) number of voice breaks and their duration; (2) dB SPL; and (3) cepstral peak prominence (CPP). Voice breaks during continuous speech are considered to be a prominent characteristic of spasmodic dysphonia. CPP analysis was selected because it can be used to analyze continuous speech and correlates well to perceptual judgment to a wide range of dysphonia severity. CPP provides a measure of the strength of the fundamental frequency within background aperiodicity. CPP is negatively correlated with dysphonia severity. An increase of around 3 dB in CPP was found to be associated with a significant improvement of voice quality pre to post treatment in patients with voice disorders. In addition, participants judged their own voice effort (on a scale from 0 to 10) to obtain a subjective indicator of whether the application of VTS reduced their effort during speech production effort.

The voice data reported below in Table 2 are for the pre-test, two periods following vibration (with the vibrator off), and 20 minutes later after the last vibration session. Five subjects were previously diagnosed with adductor spasmodic dysphonia (ADSD) (2, 4, 7, 8, 10) and one with abductor spasmodic dysphonia (ABSD) (5). For ADSD the sentences for adductor analysis were used and for ABSD the abductor sentences were used for analysis consistent with Ludlow cited above.

For the five subjects with ADSD, all showed an increase of CPP after the pretest with subjects SD02, SD07, and SD08 exhibiting an increase around 3 dB. Subject SD02 and SD07 had voice breaks during the pretest but none after application of VTS and subject SD08 did not have voice breaks from the beginning. The ABSD participant showed a 75% reduction in voice breaks. Note that effects on CPP and voice breaks persisted up to 40 minutes past the last application of VTS (20 min. after last posttest [Post20 min-OFF]). Furthermore, the improvement in voice quality as measured by CPP gradually improved over the course of the experiment with increasing exposure to VTS. Further systematic analysis often SD subjects showed that in response to VTS, 80% of patients (8/10) exhibited improvements in at least one objective measure of voice quality—either a reduction in the number of voice breaks and/or meaningful increases in voice CPP (+3 db) or both.

Equally important to note is that patients tolerated the procedure very well. The voice effort scale for all the subjects decreased with VTS. Subjects SD02 and SD10 showed 83% and 86% decrease in the voice effort scale.

To summarize, the present inventors confirmed in a small sample of SD patients that VTS induced acute voice quality improvements that persisted for 20 minutes after cessation of VTS. Equally important, patients tolerated the procedure very well. Improvements in markers of voice quality evolved gradually of the course of the application of VTS. The results of these voice data presenting a high likelihood that improvements of similar scope can be confirmed in a larger sample of patients.

TABLE 2
Effects of vibro-tactile stimulation on voice quality in spasmodic
dysphonia. Data are from 6 SD patients (5 adductor and 1 abductor SD).
(OFF indicates that vibrators were off during the recording.)

| | | | # of | Voice |
|---|---|---|---|---|
| | | CPP | Voice | effort |
| | Condition | (dB) | breaks | scale |
| SD | Pre-test | 17.8 | 4 | 3 |
| 02 | Post1-OFF | 20.5 | 0 | 1 |
| (Add [symbol] | Post2-OFF | 20.5 | 0 | 0.5 |
| | Post20min- | 20.74 | 0 | 0.5 |
| | OFF | | | |
| SD 04 | Pre-test | 18.8 | 0 | 2 |
| (Adductor) | Post1-OFF | 18.9 | 0 | 1 |
| | Post2-OFF | 18.8 | 0 | 1 |
| | Post20min- | 20.00 | 0 | 2 |
| | OFF | | | |
| SD 07 | Pre-test | 18.66 | 9 | 5 |
| (Adductor) | Post1-OFF | 21.45 | 0 | 4 |
| | Post2-OFF | 21.22 | 0 | 3 |
| | Post20min- | 21.49 | 0 | 4 |
| | OFF | | | |
| SD 08 | Pre-test | 6.498 | 0 | 4 |
| (Adductor) | Post1-OFF | 9.146 | 0 | 4 |
| | Post2-OFF | 9.783 | 0 | 2 |
| | Post20min- | 9.084 | 0 | 3 |
| | OFF | | | |
| SD 10 | Pre-test | 13.39 | 2 | 7 |
| (Adductor) | Post1-OFF | 14.92 | 5 | 6 |
| | Post2-OFF | 14.86 | 6 | 6 |
| | Post20min- | 14.379 | 1 | 1 |
| | OFF | | | |
| SD 05 | Pre-test | 21.48 | 12 | 3 |
| (Abductor) | Post1-OFF | 21.35 | 10 | 3 |
| | Post2-OFF | 21.00 | 2 | 4 |
| | Post20min- | 21.20 | 3 | 3 |
| | OFF | | | |

[symbol]

indicates data missing or illegible when filed

### Example 3

The present inventors discovered that VTS of the posterior neck muscles (m. trapezius) with a hand-held device that applied VTS similar to that of FIG. 2 can have an acute effect on the head posture of people with cervical dystonia. In a case study, a 54-old person with cervical dystonia received VTS to the posterior neck muscles of the affected side. VTS induced lengthening of the dystonic neck muscles. Neither haptic stimulation nor transcutaneous electrical stimulation had more than a marginal effect. The marked difference in the change of head position after short and prolonged stimulation (typically in a range between 1 and 15 minutes) supports the notion that cervical dystonia (spasmodic torticollis) results from a disturbance of the central processing of the afferent input conveying head position information—at least in those patients who are sensitive to sensory stimulation in the neck region. This finding supports the claim that prolonged neck muscle vibration (e.g., vibration applied for a period of several minutes or longer—greater than 1 minute, in some embodiments 15 minutes or longer) with the device of FIG. 2 may provide a convenient non-invasive method for treating spasmodic torticollis at the central level by influencing the neural control of head on trunk position. This type of prolonged VTS is distinguished from VTS to induce swallowing, which is applied in a single short burst in the magnitude of milliseconds or seconds.

Although the present disclosure has been described with reference to preferred embodiments, workers skilled in the art will recognize that changes can be made in form and detail without departing from the spirit and scope of the present disclosure.

What is claimed is:

1. A system for treating a patient having focal dystonia of the head, neck or voice, the system comprising:
a device including:
a collar;
first and second vibrators supported by and spaced along the collar; wherein the vibrators are configured to deliver amplitudes between 0.5 and 15 G at a frequency between 2-120 Hz; and
a power source configured to provide power to the first and second vibrators.

2. The system of claim 1, wherein the device is configured to automatically activate the vibrators when the patient speaks.

3. The system of claim 2, wherein the device includes a microphone, electromyographic sensor, inertial sensor or accelerometer configured to detect when the patient wearing the device is speaking.

4. The system of claim 2, wherein the device is configured to automatically cease vibration produced from the vibrators when the patient stops speaking.

5. The system of claim 1, wherein a position of the first and second vibrators on the collar is adjustable.

6. The system of claim 1, further comprising a control unit configured for a user to manually activate the first and second vibrators.

7. The system of claim 1, wherein the system is configured to provide continuous vibration via the vibrators when the device is turned on for an adjustable time interval between 1-15 minutes.

8. A method of treating symptoms of focal dystonia of the head, neck and voice, the method comprising the steps of:
providing a device comprising a collar including two vibrators and a power source configured to provide power to the two vibrators;
positioning the collar around a neck of a patient; and
activating the two vibrators to apply vibration to the neck, the vibration having a frequency between 2-120 Hz and an amplitude between 0.5-15 G.

9. The method of claim 8, wherein a control unit is provided, wherein the step of activating the vibrators is controlled with the control unit; wherein the control unit includes a mobile phone application, tablet application or computer software.

10. The method of claim 8, wherein the two vibrators are activated continuously; wherein continuously is defined as a range between 1 minute and 2 hours.

11. The method of claim 8, wherein the step of activating is conducted automatically when the patient speaks.

12. The method of claim 11, wherein the device is configured to automatically cease vibration produced from the vibrators when the patient stops speaking.

13. The method of claim 11, wherein the vibrators produce the vibration 0.1 seconds or less after the patient speaks.

14. The method of claim 11, wherein the device includes a microphone provided in the collar to sense when the patient speaks.

15. The method of claim 11, wherein the device includes an accelerometer provided in the collar to sense when the patient speaks.

16. The method of claim 11, wherein the device includes an electromyographic sensor provided in the collar to sense when the patient speaks or when involuntary spasms of the neck muscles occur.

17. The method of claim 11, wherein the device includes an inertial sensor to sense when a person speaks.

18. The method of claim 8, wherein the two vibrators are positioned superficially on opposing sides of thyroid cartilage of the larynx of the patient.

19. The method of claim 8, wherein the two vibrators are positioned on the neck above sternocleidomastoid or trapezius muscles of the patient.
